(19) United States
(12) Patent Application Publication
(10) Pub. No.: US 2024/0272619 A1
(43) Pub. Date: Aug. 15, 2024

(54) NUMERICAL CONTROL DEVICE

(71) Applicant: Fanuc Corporation, Minamitsuru-gun, Yamanashi (JP)

(72) Inventor: Nobuhito Oonishi, Minamitsuru-gun, Yamanashi (JP)

(73) Assignee: Fanuc Corporation, Minamitsuru-gun, Yamanashi (JP)

(21) Appl. No.: 18/568,962

(22) PCT Filed: Jul. 1, 2021
(86) PCT No.: PCT/JP2021/024998

§ 371 Date: Dec. 11, 2023

(51) Int. Cl. G05B 19/4155

(52) U.S. Cl. CPC G05B 19/4155; G05B 2219/32105

(57) ABSTRACT

A numerical control device includes: a command analysis unit that analyzes a processing program which includes, in one block, a first command including a numerical value defining shaft operation, a second command including any of a preparation function command, a speed command, a main shaft rotation command, a tool exchange command, and an auxiliary command, and a third command defining the execution timing of the second command; and a command information generation unit that generates command information of the second command on the basis of the first command and the third command which have been analyzed by the command analysis unit.

### CROSS REFERENCE TO RELATED APPLICATIONS

This is the U.S. National Phase application of PCT/JP2021/024998, filed Jul. 1, 2021, the disclosures of this application being incorporated herein by reference in its entirety for all purposes.

### FIELD OF THE INVENTION

The present disclosure relates to a numerical controller that controls a machine tool.

### BACKGROUND ART

In numerical controllers, it is conventionally proposed to use a machining program in which multiple sets of command values are arrayed in a single block (for example, Patent Literature 1). Machining programs having such a command format provide commands for execution of a continuous operation in a machine tool by using multiple sets of command values designated in a single block.

### PATENT LITERATURE

Patent Literature 1: Japanese Patent Application Laid-Open No. 2020-98428

### SUMMARY OF THE INVENTION

In the machining programs having such a command format, however, a large number of numerical values are arrayed in a single block, and this may reduce readability of a machining program. Further, since it is required to define respective numerical values in advance, creation of a machining program will be a large burden on a worker.

The present disclosure intends to provide a numerical controller that can reduce the burden in creating a machining program in which multiple sets of command values are arrayed in a single block.

A numerical controller includes: a command analysis unit that analyzes a machining program including a first command, a second command, and a third command in a signal block, the first command including a numerical value defining an axis operation, the second command including any of a preparation function command, a feedrate command, a spindle rotation command, a tool exchange command, and an auxiliary command, and the third command defining an execution timing of the second command; and a command information generation unit that generates command information for the second command based on the first command and the third command analyzed by the command analysis unit.

According to one aspect of the present disclosure, it is possible to reduce the burden in creating a machining program in which multiple sets of command values are arrayed in a single block.

### BRIEF DESCRIPTION OF DRAWINGS

FIG. 1 is a block diagram illustrating an example of a hardware configuration of a numerical controller.

FIG. 2 is a block diagram illustrating an example of functions of the numerical controller.

FIG. 3 is a diagram illustrating an example of a machining program.

FIG. 4 is a diagram illustrating an example of an execution timing of a feedrate command.

FIG. 5 is a flowchart illustrating an example of a flow of a process performed by the numerical controller.

FIG. 6 is a diagram illustrating an example of a machining program.

FIG. 7 is a diagram illustrating an operation of a control axis when the machining program illustrated in FIG. 6 is executed.

FIG. 8 is a diagram illustrating an example of a machining program.

FIG. 9 is a diagram illustrating an example of a machining program.

FIG. 10 is a diagram illustrating an example of a machining program.

FIG. 11 is a diagram illustrating an example of a machining program.

FIG. 12 is a diagram illustrating an operation of a control axis and a coolant when the machining program illustrated in FIG. 11 is executed.

FIG. 13 is a diagram illustrating an example of a machining program.

### DETAILED DESCRIPTION OF EMBODIMENTS OF THE INVENTION

One embodiment of the present disclosure will be described below with reference to the drawings. Note that a solution to the problem does not necessarily require all the features in combination that are described in the following embodiment. Further, more detailed description than is needed may be omitted. Further, the description of the following embodiment and the drawings are provided for those skilled in the art to fully understand the present disclosure and are not intended to limit the scope of the claims.

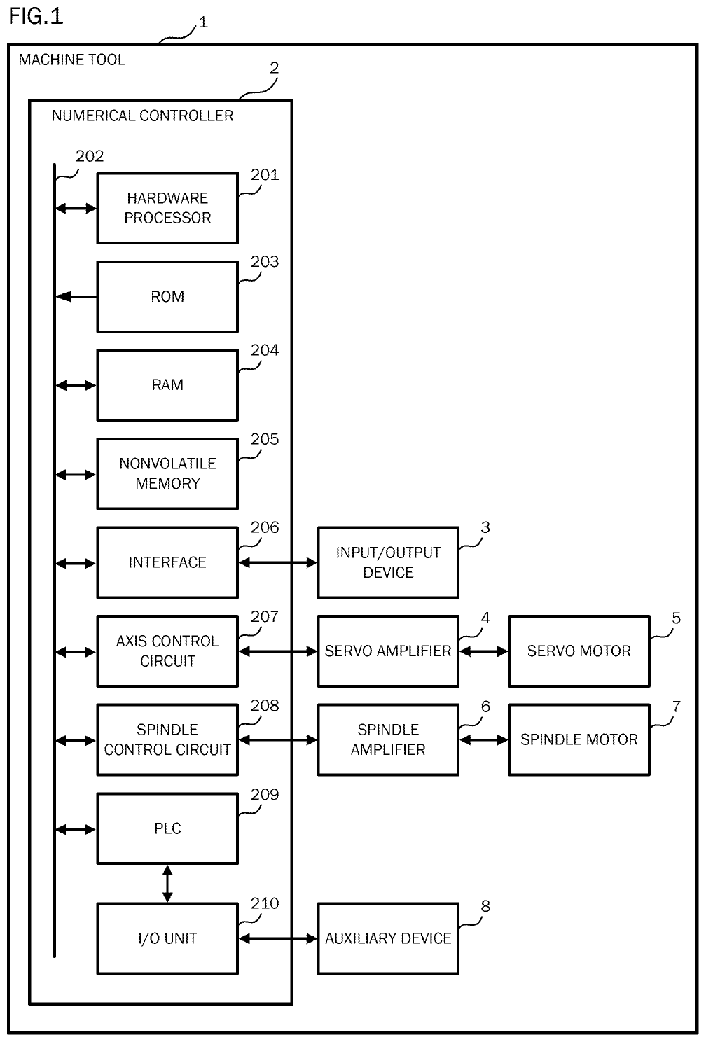

FIG. 1 is a block diagram illustrating an example of a hardware configuration of a machine tool having a numerical controller. A machine tool 1 includes a lathe, a machining center, and a multi-tasking machine. The machine tool 1 may include a wire electric discharge machine.

The machine tool 1 has a numerical controller 2, an input/output device 3, a servo amplifier 4 and a servo motor 5, a spindle amplifier 6 and a spindle motor 7, and an auxiliary device 8.

The numerical controller 2 is a device that controls the entire machine tool 1. The numerical controller 2 has a hardware processor 201, a bus 202, a read-only memory (ROM) 203, a random-access memory (RAM) 204, and a nonvolatile memory 205.

The hardware processor 201 is a processor that controls the entire numerical controller 2 in accordance with a system program. The hardware processor 201 reads a system program or the like stored in the ROM 203 via the bus 202 and performs various processes based on the system program. Further, the hardware processor 201 controls the servo motor 5 and the spindle motor 7 based on a machining program. For example, the hardware processor 201 is a central processing unit (CPU) or an electronic circuit.

The hardware processor 201 performs analysis of a machining program and output of control commands for the servo motor 5 and the spindle motor 7, for example, on a control cycle basis.

The bus 202 is a communication path connecting respective hardware components within the numerical controller 2 to each other. Respective hardware components within the numerical controller 2 transfer data to each other via the bus 202.

The ROM 203 is a storage device that stores a system program or the like for controlling the entire numerical controller 2. The ROM 203 is a computer readable storage medium.

The RAM 204 is a storage device that temporarily stores various data. The RAM 204 functions as a working area where the hardware processor 201 processes the various data.

The nonvolatile memory 205 is a storage device that retains data even in a state where the machine tool 1 is powered off and no power is supplied to the numerical controller 2. For example, the nonvolatile memory 205 stores a machining program and various parameters. The nonvolatile memory 205 is a computer readable storage medium. For example, the nonvolatile memory 205 is formed of a solid state drive (SSD).

The numerical controller 2 further has an interface 206, an axis control circuit 207, a spindle control circuit 208, a programmable logic controller (PLC) 209, and an I/O unit 210.

The interface 206 connects the bus 202 and the input/output device 3 to each other. For example, the interface 206 transmits various data processed by the hardware processor 201 to the input/output device 3.

The input/output device 3 is a device that receives various data via the interface 206 and displays the various data. Further, the input/output device 3 accepts input of various data and transmits the various data to the hardware processor 201 via the interface 206. For example, the input/output device 3 is a touch panel. When the input/output device 3 is a touch panel, the touch panel is a capacitive type touch panel, for example. Note that the touch panel may be other types of touch panels without being limited to the capacitance type. For example, the input/output device 3 is mounted on an operation panel (not illustrated) in which the numerical controller 2 is stored.

The axis control circuit 207 is a circuit that controls the servo motor 5. The axis control circuit 207 outputs a command for driving the servo motor 5 to the servo amplifier 4 in response to a control command from the hardware processor 201. For example, the axis control circuit 207 transmits a torque command used for controlling the torque of the servo motor 5 to the servo amplifier 4.

The servo amplifier 4 supplies current to the servo motor 5 in response to a command from the axis control circuit 207.

The servo motor 5 is supplied with current from the servo amplifier 4 and driven thereby. For example, the servo motor 5 is coupled to a ball screw that drives a tool post. In response to the servo motor 5 being driven, a structure of the machine tool 1, such as a tool post, moves in an X-axis direction, a Y-axis direction, or a Z-axis direction, for example. Note that the servo motor 5 may have a built-in velocity detector (not illustrated) that determines the feed rate of each feed axis.

The spindle control circuit 208 is a circuit for controlling the spindle motor 7. The spindle control circuit 208 outputs a command used for driving the spindle motor 7 to the spindle amplifier 6 in response to a control command from the hardware processor 201. For example, the spindle control circuit 208 transmits a torque command used for controlling the torque of the spindle motor 7 to the spindle amplifier 6.

The spindle amplifier 6 supplies current to the spindle motor 7 in response to a command from the spindle control circuit 208.

The spindle motor 7 is supplied with current from the spindle amplifier 6 and driven thereby. The spindle motor 7 is coupled to the spindle and rotates the spindle.

The PLC 209 is a device that executes a ladder program to control the auxiliary device 8. The PLC 209 transmits a command to the auxiliary device 8 via the I/O unit 210.

The I/O unit 210 is an interface that connects the PLC 209 and the auxiliary device 8 to each other. The I/O unit 210 transmits a command received from the PLC 209 to the auxiliary device 8.

The auxiliary device 8 is a device that is installed in the machine tool 1 and performs auxiliary operations in the machine tool 1. The auxiliary device 8 operates based on a command received from the I/O unit 210. The auxiliary device 8 may be a device installed around the machine tool 1. For example, the auxiliary device 8 is a tool exchanger, a cutting fluid injector, or an opening/closing door drive device.

Next, the function of the numerical controller 2 will be described.

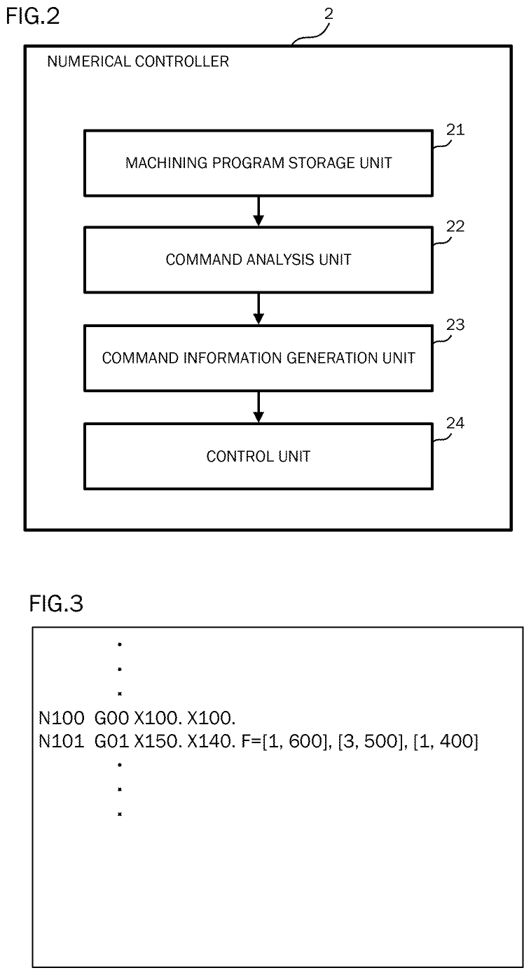

FIG. 2 is a block diagram illustrating an example of functions of the numerical controller 2. The numerical controller 2 includes a machining program storage unit 21, a command analysis unit 22, a command information generation unit 23, and a control unit 24.

The machining program storage unit 21 is implemented when a machining program input from the input/output device 3 is stored in the RAM 204 or the nonvolatile memory 205, for example.

For example, the command analysis unit 22, the command information generation unit 23, and the control unit 24 are implemented when the hardware processor 201 performs calculation processing by using a system program stored in the ROM 203 and various data stored in the nonvolatile memory 205.

The machining program storage unit 21 stores a machining program used for machining a workpiece.

FIG. 3 is a diagram illustrating an example of a machining program. For example, the machining program includes a single block including a plurality of commands.

A single block means a single line of a machining program. That is, the line of sequence number N100 in the machining program illustrated in FIG. 3 corresponds to a single block. Further, the line of sequence number N101 corresponds to a single block.

The plurality of commands include a first command, a second command, and a third command.

The first command includes a numerical value defining an axis operation, for example. The axis operation is an operation in which a control axis is moved along an axis such as the X-axis or the Y-axis or an operation in which a control axis is stopped. The axis operation includes the control axis standing by without moving, that is, remaining in a stop state.

For example, the numerical value defining the axis operation is a coordinate value in a predetermined coordinate system. In the example illustrated in FIG. 3, a coordinate value “X150. Y140.” in a predetermined coordinate system is designated as the first command in the block of sequence number N101. Note that the predetermined coordinate system is a machine coordinate system of the machine tool 1 or a workpiece coordinate system, for example. The numerical value defining an axis operation may be a motion amount of an axis in a predetermined coordinate system. Further, the numerical value defining an axis operation may be an execution time. An example where the numerical value defining the axis operation is an execution time will be described later in detail.

The second command includes any of a preparation function command, a feedrate command, a spindle rotation command, a tool exchange command, and an auxiliary command.

The preparation function command is a command to perform internal settings of the numerical controller 2 for machining preparation. For example, the preparation function command is a command with a G code such as G00, G01, G02, G03, and G04. Note that G00 is a positioning command, G01 is a linear interpolation command, G02 is a circular interpolation command to draw a circular arc clockwise, G03 is a circular interpolation command to draw a circular arc counterclockwise, and G04 is a dwell command.

The feedrate command is a command to designate a feed rate when the control axis is moved in a cutting feed. The feedrate command is designated by an F code. In the example illustrated in FIG. 3, the feedrate commands “600”, “500”, and “400” are designated by the F code.

The spindle rotation command is a command to designate a rotational speed of the spindle. The spindle rotation command is designated by an S code.

The tool exchange command is a command for replacing a tool. The tool exchange command is designated by a T code.

The auxiliary command is a command for performing a function other than the operation of the control axis. The auxiliary command is designated by an M code.

The third command is a command to define an execution timing of the second command. The execution timing refers to a time that the second command becomes enabled or a period during which the second command is enabled. The third command includes any of a numerical value indicating a position, a numerical value indicating an operation distance, a numerical value indicating an operation time, a numerical value indicating a ratio of operation distances, and a numerical value indicating a ratio of operation times in an axis operation.

In the example illustrated in FIG. 3, the numerical values “1”, “3”, and “1” indicating a ratio of operation distances are designated as the third command for the second commands “600”, “500”, and “400”, respectively. That is, the third command specifies a period during which the second command is enabled by a numerical value indicating a ratio of operation distances. The numerical values “1”, “3”, and “1” may be a ratio of operation times of the control axis instead of a ratio of operation distances. Further, whether the third command represents a ratio of operation distances or a ratio of operation times or the like may be set by a predetermined parameter in advance. Furthermore, to explicitly defines that the second command is a ratio of operation distances, a command such as “RATIO_LENGTH” may be designated in a machining program.

Further, a numerical value indicating a position, a numerical value indicating an operation distance, a numerical value indicating an operation time, and a numerical value indicating a ratio of operation times may be designated by, for example, POS{X}, LENGTH{X}, TIME, and RATIO_TIME, respectively. Further, the third command may be designated by a combined distance LENGTH without involving designation of an axis direction. Now turning back to FIG. 2, the description of the function of the numerical controller 2 is continued.

The command analysis unit 22 analyzes a machining program including, in a single block, the first command including a numerical value defining an axis operation, the second command including any of a preparation function command, a feedrate command, a spindle rotation command, a tool exchange command, and an auxiliary command, and the third command defining an execution timing of the second command. The command analysis unit 22 reads a machining program stored in the machining program storage unit 21 and analyzes each command included in each block of the machining program.

The command analysis unit 22 reads and analyzes each command designated by a machining program on a block basis. The command analysis unit 22 may sequentially prefetch a command of each block for analysis.

For example, the block of sequence number N100 illustrated in FIG. 3 designates “G00 X100. Y100.”. The command analysis unit 22 interprets the command of this block as a command to move the control axis in a rapid traverse to the position at X100, Y100.

Further, the block of sequence number N101 designates “G01 X150. Y140. F=[1, 600], [3, 500], [1, 400]”. The command analysis unit 22 interprets the command of this block as a command to move the control axis from a position at X100, Y100 to a position at X150, Y140 in a cutting feed. Further, the command analysis unit 22 interprets the command as a command to move the control axis at a feed rate of 600 [mm/min] in a section of the first ⅕ distance between the position at X100, Y100 and the position at X150, Y140. Further, the command analysis unit 22 interprets the command as a command to move the control axis at a feed rate of 500 [mm/min] in a section of the next ⅗ distance. Further, the command analysis unit 22 interprets the command as a command to move the control axis at a feed rate of 400 [mm/min] in a section of the last ⅕ distance.

The command information generation unit 23 generates command information for the second command based on the first command and the third command analyzed by the command analysis unit 22.

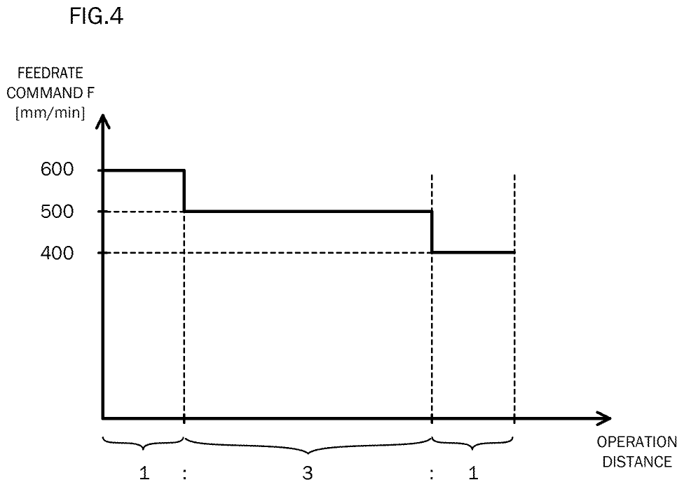

FIG. 4 is a diagram illustrating an example of an execution timing of the feedrate command. Specifically, FIG. 4 is a graph illustrating an execution timing of a feedrate command when the machining program illustrated in FIG. 3 is executed.

Based on a result of analysis performed by the command analysis unit 22 on the machining program illustrated in FIG. 3, the command information generation unit 23 generates command information to move the control axis at a feed rate of 600 [mm/min] in the section of the first ⅕ distance between the position at X100, Y100 and the position at X150, Y140. In other words, the command information generation unit 23 generates command information to perform a cutting feed with linear interpolation at a feed rate of 600 [mm/min] from the position at X100, Y100 toward the position at X110, Y108.

Further, the command information generation unit 23 generates command information to move the control axis at a feed rate of 500 [mm/min] in the section of the next ⅗ distance between the position at X100, Y100 and the position at X150, Y140. In other words, the command information generation unit 23 generates command information to perform a cutting feed with linear interpolation at a feed rate of 500 [mm/min] from the position at X110, Y108 toward the position at X140, Y132.

Further, the command information generation unit 23 generates command information to move the control axis at a feed rate of 400 [mm/min] in the section of the last ⅕ distance between the position at X100, Y100 and the position at X150, Y140. In other words, the command information generation unit 23 generates command information to perform a cutting feed with linear interpolation at a feed rate of 400 [mm/min] from the position at X140, Y132 toward the position at X150, Y140.

That is, the command information generation unit 23 generates a control command so that, in the operation of the control axis by the first command, the ratio of operation distances of the section for the operation at a feed rate of 600 [mm/min], the section for the operation at a feed rate of 500 [mm/min], and the section for the operation at a feed rate of 400 [mm/min] is 1:3:1.

The control unit 24 controls each unit of the machine tool 1 based on the command information generated by the command information generation unit 23. For example, the control unit 24 controls the operation of a spindle head, a tool post, or the like by controlling the control axis such as the X-axis, the Y-axis, and the Z-axis. Accordingly, the numerical controller 2 can cause the machine tool 1 to machine a workpiece.

Next, a flow of the process performed by the numerical controller 2 will be described.

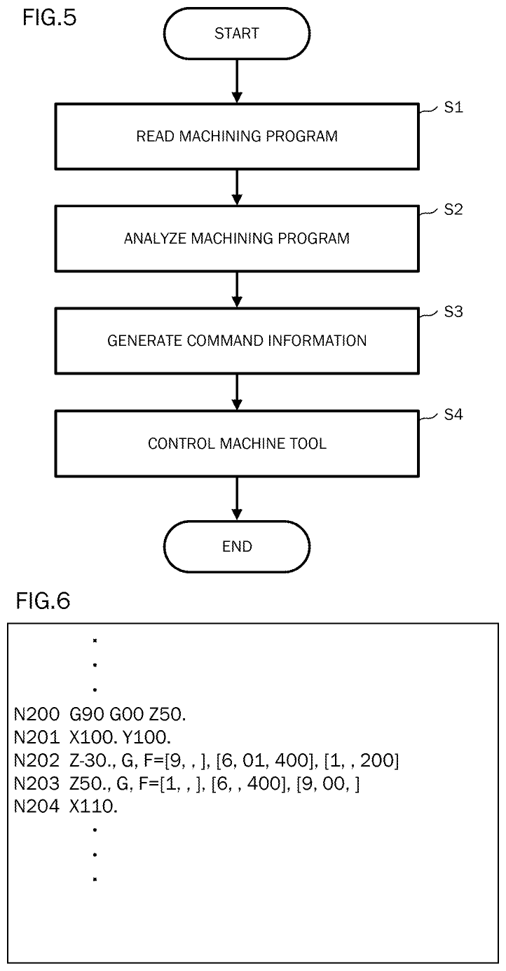

FIG. 5 is a flowchart illustrating an example of a flow of the process performed by the numerical controller 2.

First, the command analysis unit 22 reads a machining program stored in the machining program storage unit 21 (step S1).

Next, the command analysis unit 22 analyzes commands of the read machining program to interpret each command (step S2).

Next, the command information generation unit 23 generates command information based on each command of the machining program interpreted by the command analysis unit 22 (step S3).

Finally, the control unit 24 controls each unit of the machine tool 1 based on the command information generated by the command information generation unit 23 (step S4) and ends the process.

As described above, the numerical controller 2 includes the command analysis unit 22 that analyzes a machining program including, in a single block, the first command including a numerical value defining an axis operation, the second command including any of a preparation function command, a feedrate command, a spindle rotation command, a tool exchange command, and an auxiliary command, and the third command defining an execution timing of the second command; and the command information generation unit 23 that generates command information for the second command based on the first command and the third command analyzed by the command analysis unit 22.

Accordingly, the numerical controller 2 can generate command information based on a machining program including the first command, the second command, and the third command in a single block. That is, the numerical controller 2 can reduce the burden in creating a machining program in which multiple sets of command values are arrayed in a single block.

Further, the numerical value defining an axis operation includes any of a coordinate value, a motion amount, and an execution time. Furthermore, the third command includes any of a numerical value indicating a position, a numerical value indicating an operation distance, a numerical value indicating an operation time, a numerical value indicating a ratio of operation distances, and a numerical value indicating a ratio of operation times in an axis operation. That is, the numerical controller 2 can generate command information based on various types of the third command. As a result, the worker is able to create a machining program to be executed in the numerical controller 2 in accordance with the operation manner of a control axis. In other words, the numerical controller 2 can reduce the burden on the worker in creating a program.

In the above description of the embodiment, the example when the second command includes only the feedrate command, that is, the second command is of one type of commands has been described. However, the second command may include multiple types of commands.

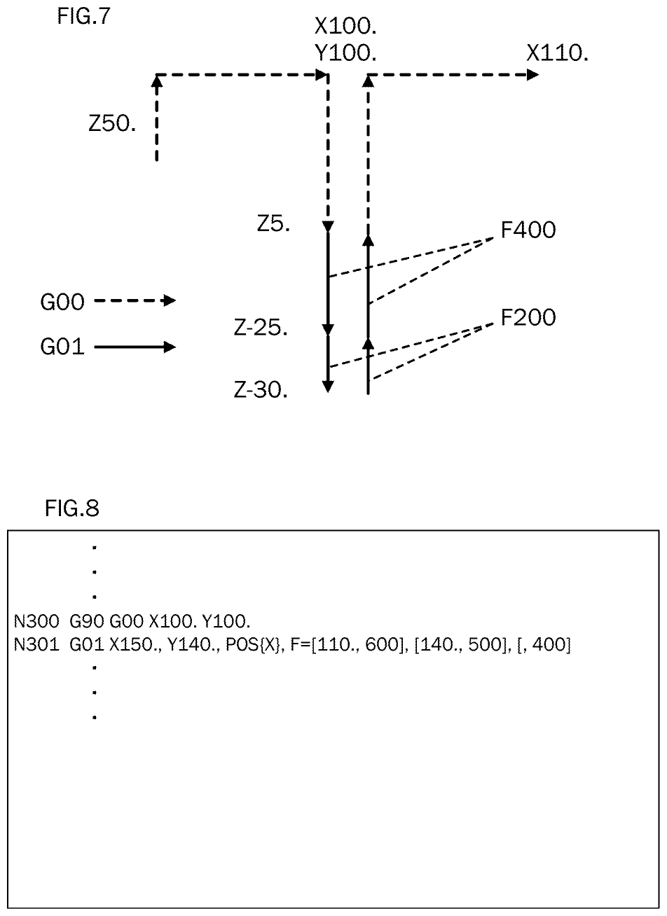

FIG. 6 is a diagram illustrating an example of a machining program. FIG. 7 is a diagram illustrating the operation of a control axis when the machining program illustrated in FIG. 6 is executed. The block of sequence number N200 designates “G90 G00 Z50.”. The command G90 is an absolute command. Under the absolute command, an axis operation is performed based on a coordinate value in a set coordinate system. Therefore, the command analysis unit 22 interprets the command designated in the block of sequence number N200 as a command to move the control axis in a rapid traverse to the position at Z50.

Note that G00 is a modal command. The modal command is a command that is not disabled until another G code belonging to one group is instructed. The commands G00, G01, G02, G03, and G04 are commands belonging to one group. That is, when G00 is designated in one block, G00 is enabled until another command such as G01 is designated in another block subsequent to the one block.

The block of sequence number N201 designates “X100. Y100.”. Further, no G code is designated in the block of sequence number N201, and G00 designated in the block of sequence number N200 is still enabled. Therefore, the command analysis unit 22 interprets the command designated in the block of sequence number N201 as a command to move the control axis in a rapid traverse to the position at X100, Y100.

The block of sequence number N202 designates “Z−30., G, F=[9, , ], [6, 01, 400], [1, , 200]”. In this command, “Z−30.” is the first command. Further, G00 is also enabled for “Z−30.” designated in sequence number N202.

The command “G, F=[9, , ], [6, 01, 400], [1, , 200]” is a command combining the second command and the third command. The address “G, F” and also the numerical values indicated at the center and the numerical values indicated on the right side within respective square brackets are the second commands, respectively. That is, “400” and “200” designated within the center square bracket and the right square bracket are the second commands, respectively. Note that, since it is considered that G00 is designated within the left square bracket, designation of numerical values corresponding to the address F is omitted.

The G code such as G00, G01, or the like is a modal command as described above. Thus, designation of numerical values at the center within the left and right square brackets is omitted.

The commands “9”, “6”, and “1” designated within the left square bracket, the center square bracket, and the right square bracket are the third commands designated for the second commands, respectively. The third command is a numerical value indicating a ratio of operation distances.

Therefore, the command analysis unit 22 interprets the command designated by sequence number N202 as a command to move the control axis in a rapid traverse in a section of the first 9/16 distance between the position at Z50 and the position at Z−30. Further, the command analysis unit 22 interprets the command as a command to move the control axis at a feed rate of 400 [mm/min] in a section of the next 6/16 distance between the position at Z50 and the position at Z−30. Further, the command analysis unit 22 interprets the command as a command to move the control axis at a feed rate of 200 [mm/min] in a section of the last 1/16 distance between the position at Z50 and the position at Z−30.

Once the command designated by sequence number N202 is analyzed, the command information generation unit 23 generates a command to move the control axis in a rapid traverse from the position at Z50 to the position at Z5. Further, the command information generation unit 23 generates command information to cause the control axis to perform a cutting feed at a feed rate of 400 [mm/min] from the position at Z5 to the position at Z−25. Further, the command information generation unit 23 generates command information to cause the control axis to perform a cutting feed at a feed rate of 200 [mm/min] from the position at Z−25 to the position at Z−30.

The block of sequence number N203 designates “Z50., G, F=[1, , ], [6, , 400], [9, 00, ]”. In this command, “z50.” is the first command.

Further, the command “G, F=[1, , ], [6, , 400], [9, 00, ]” is a command combining the second command and the third command. The address “G, F” and also the numerical values indicated at the center and the numerical values indicated on the right side within respective square brackets are the second commands, respectively. That is, “400” and “00” designated within the left square bracket, the center square bracket, and the right square bracket are the second commands, respectively.

The G code such as G00, G01, or the like is a modal command as described above. Thus, designation of numerical values at the center within the left and center square brackets and the numerical values on the right side within the left square bracket is omitted.

The commands “1”, “6”, and “9” designated within the left square bracket, the center square bracket, and the right square bracket are the third commands designated for the second commands, respectively. The third command is a numerical value indicating a ratio of operation distances.

Therefore, the command analysis unit 22 interprets the command designated by sequence number N203 as a command to move the control axis at a feed rate of 200 [mm/min] in a section of the first 1/16 distance between the position at Z−30 and the position at Z50. Further, the command analysis unit 22 interprets the command as a command to move the control axis at a feed rate of 400 [mm/min] in a section of the next 6/16 distance between the position at Z−25 and the position at Z5. The command analysis unit 22 interprets the command as a command to move the control axis in a rapid traverse in a section of the last 9/16 distance between the position at Z5 and the position at Z50.

Once the command designated by sequence number N203 is analyzed, the command information generation unit 23 generates command information to cause the control axis to perform a cutting feed at a feed rate of 200 [mm/min] from the position at Z−30 to the position at Z−25. Further, the command information generation unit 23 generates command information to cause the control axis to perform a cutting feed at a feed rate of 400 [mm/min] from the position at Z−25 to the position at Z5. Further, the command information generation unit 23 generates command information to move the control axis in a rapid traverse from the position at Z5 to the position at Z50.

The block of sequence number N204 designates “X110.”. Therefore, the command analysis unit 22 interprets the command designated by sequence number N204 as a command to move the control axis in a rapid traverse to the position at X110. The command information generation unit 23 generates command information to cause the control axis to perform a rapid traverse from the position at X100 to the position at X110.

As described above, the command analysis unit 22 may analyze a machining program including multiple types of second commands in a single block. In such a case, the machining program is simplified, and this can reduce the burden on the worker in creating the machining program.

In the embodiment described above, the third command is a numerical value indicating a ratio of operation distances in an axis operation. The third command may be a numerical value indicating a position. The numerical value indicating the position is, for example, a coordinate value.

FIG. 8 is a diagram illustrating an example of a machining program. The block of sequence number N300 designates “G90 G00 X100. Y100.”. The command analysis unit 22 interprets the command designated by the block of sequence number N300 as a command to move the control axis in a rapid traverse to the position at X100, Y100.

The block of sequence number N301 designates “G01 X150., Y140., POS{X}, F=[110., 600], [140., 500], [ , 400]”. In this command, “X150., Y140.” is the first command.

The command “POS {X}, F=[110., 600], [140., 500], [ , 400]” is a command combining the second command and the third command. The address “F” and the numerical values indicated on the right side within respective square brackets are the second commands, respectively. That is, “600”, “500”, and “400” designated within the left square bracket, the center square bracket, and the right square bracket are the second commands, respectively.

Further, “110.” and “140.” designated within the left square bracket and the center square bracket are the third commands designated for the second commands, respectively. Further, since the third command within the right square bracket is the same as the first command “X150.”, the designation thereof is omitted.

The command analysis unit 22 interprets the command designated by sequence number N301 as a command to move the control axis at a feed rate of 600 [mm/min] in the first section between the position at X100, Y100 and the position at X150, Y140. Herein, the first section refers to the section from the position at X100 to the position at X110. Further, the position at X110 corresponds to Y108.

Further, the command analysis unit 22 interprets the command designated by sequence number N301 as a command to move the control axis at a feed rate of 500 [mm/min] in the next section between the position at X100, Y100 and the position at X150, Y140. Herein, the next section refers to the section from the position at X110 to the position at X140. Further, the position at X140 corresponds to Y132.

Further, the command analysis unit 22 interprets the command designated by sequence number N301 as a command to move the control axis at a feed rate of 400 [mm/min] in the last section between the position at X100, Y100 and the position at X150, Y140. Herein, the last section refers to the section from the position at X140 to the position at X150. Further, the position at X150 corresponds to Y140.

As described above, the command analysis unit 22 may analyze a machining program in which the third command is designated by numerical values indicating positions. In such a case, the machining program is simplified, and this can reduce the burden on the worker in creating the machining program. Further, because the third command is designated by numerical values indicating positions, the coordinates reached by a control axis are clarified. Further, it is possible to omit designation of some of the third commands. Moreover, it is possible to designate the third command for some of the control axes.

In the embodiment described above, the third command is a numerical value indicating a position in an axis operation. The third command may be a numerical value indicating an operation distance.

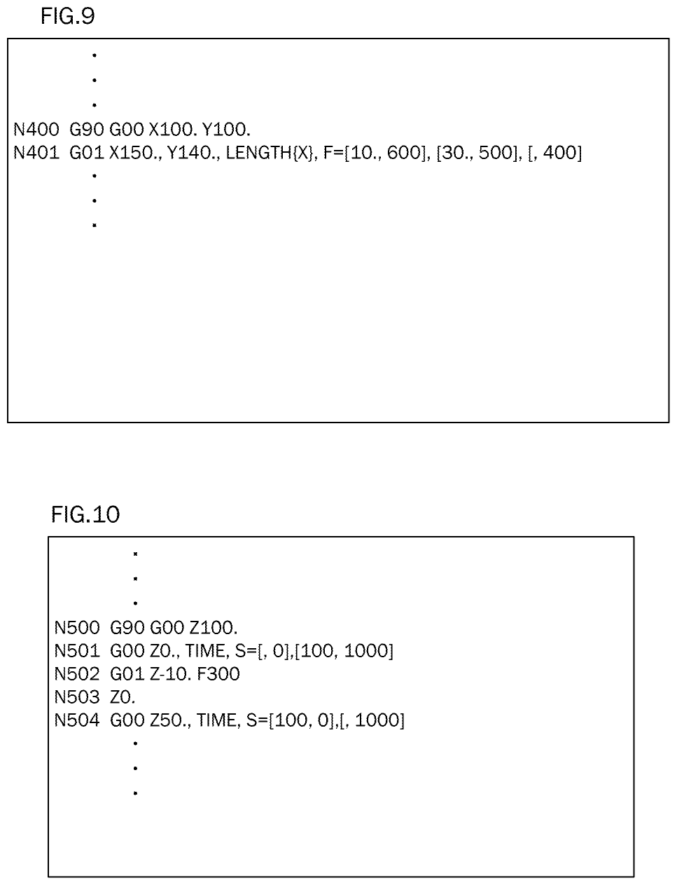

FIG. 9 is a diagram illustrating an example of a machining program. The block of sequence number N400 designates “G90 G00 X100. Y100”. The command analysis unit 22 interprets the command designated by the block of sequence number N400 as a command to move the control axis in a rapid traverse to the position at X100, Y100.

The block of sequence number N401 designates “G01 X150., Y140., LENGTH{X}, F=[10., 600], [30., 500], [ , 400]”. In this command, “X150., Y140.” is the first command.

The command “LENGTH{X}, F=[10., 600], [30., 500], [ , 400]” is a command combining the second command and the third command. The address “F” and the numerical values indicated on the right side within respective square brackets are the second commands, respectively. That is, “600”, “500”, and “400” designated within the left square bracket, the center square bracket, and the right square bracket are the second commands, respectively.

The commands “10.” and “30.” designated within the left square bracket and the center square bracket are the third commands designated for the second commands, respectively. Further, once numerical values indicating positions in the axis operation within the left square bracket and the center square bracket are designated, the third command within the right square bracket is automatically defined. Thus, the designation of the third command within the right square bracket is omitted.

The command analysis unit 22 interprets the command designated by sequence number N401 as a command to move the control axis at a feed rate of 600 [mm/min] in the first section between the position at X100, Y100 and the position at X150, Y140. Herein, the first section refers to the section between the position at X100 and the position that is distant from the position at X100 by 10 in the X-axis direction, that is, the section between the position at X100 and the position at X110. Note that the position at X110 corresponds to Y108.

Further, the command analysis unit 22 interprets the command designated by sequence number N401 as a command to move the control axis at a feed rate of 500 [mm/min] in the next section between the positions at X100, Y100 and at X150, Y140. Herein, the next section refers to the section between the position at X110 and the position that is distant from the position at X110 by 30 in the X-axis direction, that is, the section between the position at X110 and the position at X140. Note that the position at X140 corresponds to Y132.

Further, the command analysis unit 22 interprets the command designated by sequence number N401 as a command to move the control axis at a feed rate of 400 [mm/min] in the last section between the position at X100, Y100 and the position at X150, Y140. Herein, the last section refers to the section between the position at X140 and the position at X150. Note that the position at X150 corresponds to Y140.

As described above, the command analysis unit 22 may analyze a machining program in which the third command is designated by numerical values indicating operation distances. In such a case, the machining program is simplified, and this can reduce the burden on the worker in creating the machining program.

In the embodiment described above, the third command is a numerical value indicating an operation distance. The second command may be a spindle rotation command, and the third command may be a numerical value indicating an operation time.

FIG. 10 is a diagram illustrating an example of a machining program. The block of sequence number N500 designates “G90 G00 Z100.”. The command analysis unit 22 interprets the command designated by the block of sequence number N500 as a command to move the control axis in a rapid traverse to the position at Z100.

The block of sequence number N501 designates “G00 Z0., TIME, S=[ , 0], [100, 1000]”. In this command, “Z0.” is the first command.

Further, the command “TIME, S=[ , 0], [100, 1000]” is a command combining the second command and the third command. The address “S” and the numerical values indicated on the right side within respective square brackets are the second commands, respectively. That is, “0” and “1000” designated within the left square bracket and the right square bracket are the second commands, respectively.

The command “100” designated in the right square bracket is the third command designated for the second command “1000”. Further, designation of the third command within the left square bracket is omitted.

The command analysis unit 22 interprets the command designated by sequence number N501 as a command to rotate the spindle at a rotational speed of 0 [rev/min] until the time 100 [ms] before the control axis reaches the position at Z0 from the position at Z100. That is, the command analysis unit 22 interprets the command as a command to stop the rotation of the spindle during this period.

The command analysis unit 22 interprets the command designated by sequence number N501 as a command to rotate the spindle at a rotational speed of 1000 [rev/min] until the control axis reaches the position at Z0 from the time 100 [ms] before the control axis reaches the position at Z0 from the position at Z100.

The block of sequence number N502 designates “G01 Z−10. F300”. The command analysis unit 22 interprets the command designated by the block of sequence number N502 as a command to move the control axis at a feed rate of 300 [mm/min] to the position at Z−10.

The block of sequence number N503 designates “Z0.”. The command analysis unit 22 interprets the command designated by the block of sequence number N503 as a command to move the control axis at a feed rate of 300 [mm/min] to the position at Z0.

The block of sequence number N504 designates “G00 Z50., TIME, S=[100, 0], [ , 1000]”. In this command, “Z50.” is the first command.

The command “TIME, S=[100, 0], [ , 1000]” is a command combining the second command and the third command. The address “S” and the numerical values indicated on the right side within respective square brackets are the second commands, respectively. That is, “0” and “1000” designated within the left square bracket and the right square bracket are the second commands, respectively.

The command “100” designated in the left square bracket is the third command designated for the second command “0”. Further, designation of the third command within the right square bracket is omitted.

The command analysis unit 22 interprets the command designated by sequence number N504 as a command to rotate the spindle at a rotational speed of 0 [rev/min] until the time 100 [ms] before the control axis reaches the position at Z50 from the position at Z0. That is, the command analysis unit 22 interprets the command as a command to stop the rotation of the spindle during this period.

Further, the command analysis unit 22 interprets the command designated by sequence number N504 as a command to rotate the spindle at a rotational speed of 1000 [rev/min] until the control axis reaches the position at Z50 from the time 100 [ms] before the control axis reaches the position at Z50 from the position at Z0.

As described above, the command analysis unit 22 may analyze a machining program in which the second command is a spindle rotation command and the third command is designated by numerical values indicating operation times. In such a case, the machining program is simplified, and this can reduce the burden on the worker in creating the machining program.

In the embodiment described above, the second command is the spindle rotation command. The second command may be an auxiliary command.

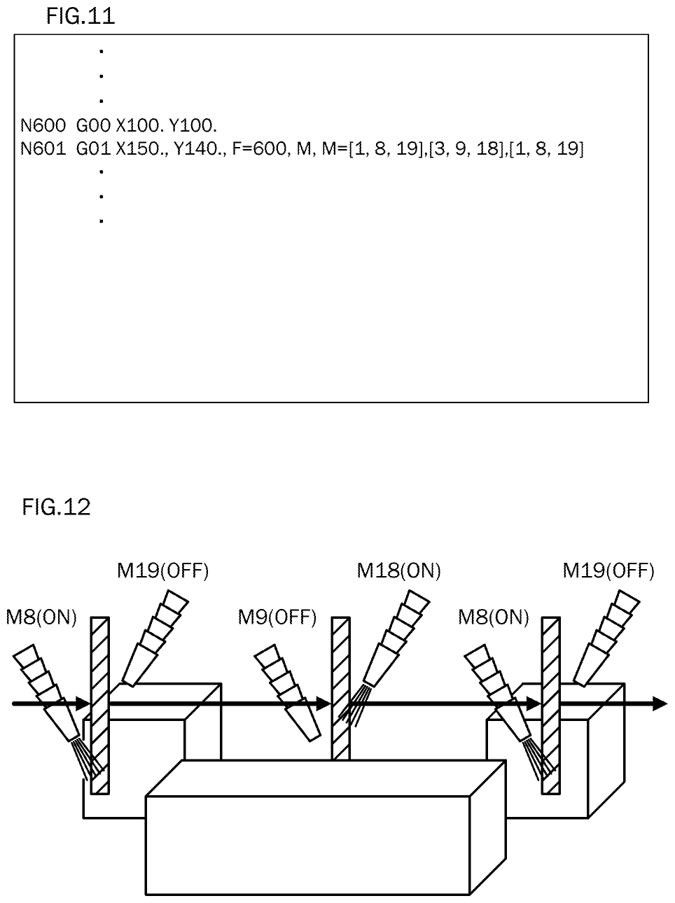

FIG. 11 is a diagram illustrating an example of a machining program. FIG. 12 is a diagram illustrating the operation of a control axis and a coolant when the machining program illustrated in FIG. 11 is executed. The block of sequence number N600 designates “G00 X100. Y100.”. The command analysis unit 22 interprets the command designated by the block of sequence number N600 as a command to move the control axis in a rapid traverse to the position at X100, Y100.

The block of sequence number N601 designates “G01 X150., Y140., F=600, M, M=[1, 8, 19], [3, 9, 18], [1, 8, 19]”. In this command, “X150., Y140.” is the first command.

Further, the command “M, M=[1, 8, 19], [3, 9, 18], [1, 8, 19]” is a command combining the second command and the third command. The address “M” and the numerical values indicated at the center and the numerical values indicated on the right side within respective square brackets are the second commands, respectively. That is, “8, 19”, “9, 18”, and “8, 19” designated within the left square bracket, the center square bracket, and the right square bracket are the second commands, respectively.

The commands “1”, “3”, and “1” designated within the left square bracket, the center square bracket, and the right square bracket are the third commands designated for the second commands, respectively. For example, the third command is a numerical value indicating a ratio of operation distances.

Therefore, the command analysis unit 22 interprets the command designated by sequence number N601 as indicating that the commands of M8 and M19 are enabled during the control axis moving in a section of the first ⅕ distance between the position at X100, Y100 and the position at X150, Y140.

Further, the command analysis unit 22 interprets the command designated by sequence number N601 as indicating that the commands of M9 and M18 are enabled during the control axis moving in a section of the next ⅗ distance between the position at X100, Y100 and the position at X150, Y140.

Further, the command analysis unit 22 interprets the command designated by sequence number N601 as indicating that the commands of M8 and M19 are enabled during the control axis moving in a section of the last ⅕ distance between the position at X100, Y100 and the position at X150, Y140.

Note that the commands M8 and M18 are commands to turn on a first coolant system and a second coolant system, respectively, in the machine tool 1 having two coolant systems. Further, the commands M9 and M19 are commands to turn off the first coolant system and the second coolant system, respectively, in the machine tool 1 having two coolant systems.

Therefore, when the control axis is moving in the first section, the first coolant system is in the on-state, and the second coolant system is in the off-state, for example. Further, when the control axis is moving in the next section, the first coolant system is in the off-state, and the second coolant system is in the on-state. Further, when the control axis is moving in the last section, the first coolant system is in the on-state, and the second coolant system is in the off-state.

As described above, the command analysis unit 22 may analyze a machining program in which the second command is designated by the auxiliary command, in particular, a command to turn on a coolant or a command to turn off a coolant. In such a case, the coolant can be turned on or off in accordance with a contact position between a tool and a workpiece when the tool machines the workpiece. Further, the machining program is simplified, and this can reduce the burden on the worker in creating the machining program.

In each embodiment described above, the example in which the first command is a coordinate value or a numerical value indicating a motion amount has been described. The first command is not limited to the above and may include a numerical value indicating an execution time.

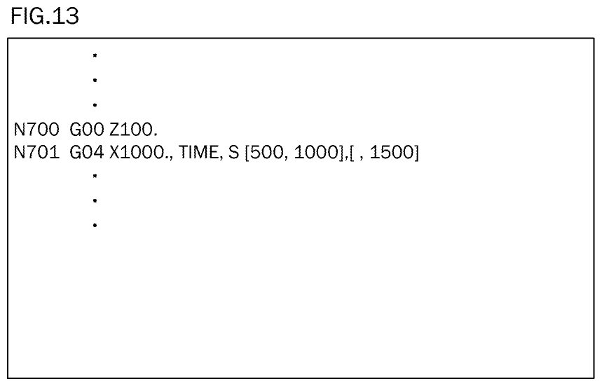

FIG. 13 is a diagram illustrating an example of a machining program. The block of sequence number N700 designates “G00 Z100.”. The command analysis unit 22 interprets the command designated by the block of sequence number N700 as a command to move the control axis in a rapid traverse to the position at Z100.

The block of sequence number N701 designates “G04 X1000., TIME, S=[500, 1000], [ , 1500]”. In this command, “X1000.” is the first command including a numerical value indicating execution time. Note that the operation on the X-axis is stopped for 1000 [ms] by the first command.

Further, the command “TIME, S=[500, 1000], [ , 1500]” is a command combining the second command and the third command. The address “S” and the numerical values indicated on the right side within respective square brackets are the second commands, respectively. That is, “1000” and “1500” designated within the left square bracket and the right square bracket are the second commands, respectively.

The command “500” designated in the left square bracket is the third command designated for the second command “1000”. Further, designation of the third command within the left square bracket is omitted.

The command analysis unit 22 interprets the command designated by sequence number N701 as a command to rotate the spindle at 1000 [rev/min] during the first 500 [ms] out of the 1000 [ms] for which the operation on the X-axis is stopped. Further, the command analysis unit 22 interprets the command as a command to rotate the spindle at 1500 [rev/min] during the remaining 500 [ms].

As described above, the command analysis unit 22 may analyze a machining program including the first command designated by numerical values indicating execution times. In such a case, the machining program is simplified, and this can reduce the burden on the worker in creating the machining program.

Note that the present disclosure is not limited to the embodiment described above and can be modified as appropriate within the scope not departing from the spirit thereof. In the present disclosure, it is possible to modify any component of the embodiment or omit any component of the embodiment.

### LIST OF REFERENCE SYMBOLS

1 machine tool
2 numerical controller
201 hardware processor
202 bus

### 203 ROM

### 204 RAM

205 nonvolatile memory
206 interface
207 axis control circuit
208 spindle control circuit

### 209 PLC

210 I/O unit
21 machining program storage unit
22 command analysis unit
23 command information generation unit
24 control unit
3 input/output device
4 servo amplifier
5 servo motor
6 spindle amplifier
7 spindle motor
8 auxiliary device

1. A numerical controller comprising:
a command analysis unit that analyzes a machining program including a first command, a second command, and a third command in a signal block, the first command including a numerical value defining an axis operation, the second command including any of a preparation function command, a feedrate command, a spindle rotation command, a tool exchange command, and an auxiliary command, and the third command defining an execution timing of the second command; and
a command information generation unit that generates command information for the second command based on the first command and the third command analyzed by the command analysis unit.

2. The numerical controller according to claim 1, wherein the numerical value defining the axis operation includes any of a coordinate value, a motion amount, and an execution time.

3. The numerical controller according to claim 1, wherein the third command includes any of a numerical value indicating a position, a numerical value indicating an operation distance, a numerical value indicating an operation time, a numerical value indicating a ratio of operation distances, and a numerical value indicating a ratio of operation times in the axis operation.
